(19) United States
(12) Patent Application Publication
(10) Pub. No.: US 2018/0162332 A1
(43) Pub. Date: Jun. 14, 2018

(54) Brake Apparatus

(71) Applicant: Hitachi Automotive Systems, Ltd., Hitachinaka-shi, Ibaraki (JP)

(72) Inventors: Chiharu NAKAZAWA, Kawasaki-shi, Kanagawa (JP); Masaki MISUNO, Atsugi-shi, Kanagawa (JP)

(21) Appl. No.: 15/738,334

(22) PCT Filed: May 19, 2016
(86) PCT No.: PCT/JP2016/064847

§ 371 Date: Dec. 20, 2017

(30) Foreign Application Priority Data
Jun. 23, 2015 (JP) 2015-125416

(51) Int. Cl. B60T 8/17; B60T 13/16; B60T 17/18; B60T 7/22

(52) U.S. Cl. CPC B60T 8/17; B60T 7/22; B60T 17/18; B60T 13/16

(57) ABSTRACT

An object of the present invention is to provide a brake apparatus capable of acquiring a desired brake hydraulic pressure when an opening failure has occurred in a shut-off valve. The brake apparatus includes a first pump configured to supply brake fluid to a hydraulic circuit connecting a master cylinder and a wheel cylinder to each other, a first shut-off valve provided between a discharge portion of the first pump in the hydraulic circuit and the master cylinder, and a second shut-off valve provided between the first shut-off valve and the master cylinder.

### TECHNICAL FIELD

The present invention relates to a brake apparatus.

### BACKGROUND ART

PTL 1 discusses a brake apparatus in which a shut-off valve is provided in a hydraulic circuit connecting a master cylinder and a wheel cylinder to each other, and a discharge portion of a pump is connected to a portion between the shut-off valve and the wheel cylinder. This brake apparatus can acquire a desired brake hydraulic pressure regardless of a brake operation performed by a driver by closing the shut-off valve and driving the pump.

### CITATION LIST

### Patent Literature

PTL 1: UK Patent Application Publication No. 2484586

### SUMMARY OF INVENTION

### Technical Problem

However, the above-described conventional technique has such a drawback that, when an opening failure has occurred in the shut-off valve, brake fluid discharged from the pump flows toward the master cylinder side, and therefore the desired brake hydraulic pressure cannot be acquired.

An object of the present invention is to provide a brake apparatus capable of acquiring the desired brake hydraulic pressure when the opening failure has occurred in the shut-off valve.

### Solution to Problem

According to embodiments of the present invention, a brake apparatus includes a first pump configured to supply brake fluid to a hydraulic circuit connecting a master cylinder and a wheel cylinder to each other, a first shut-off valve provided between a connection position where the hydraulic circuit is connected to a discharge portion of the first pump and the master cylinder, and a second shut-off valve provided between the first shut-off valve and the master cylinder.

Therefore, even when the opening failure has occurred in the first shut-off valve, the desired brake hydraulic pressure can be acquired by closing the second shut-off valve and driving the first pump.

### BRIEF DESCRIPTION OF DRAWINGS

FIG. 1 is a perspective view of a brake apparatus according to a first embodiment.

FIG. 2 illustrates a hydraulic circuit of the brake apparatus according to the first embodiment.

FIG. 3 is a flowchart illustrating a flow of boosting control by a boosting control portion 41d according to the first embodiment.

FIG. 4 illustrates a hydraulic circuit of a brake apparatus according to a third embodiment.

FIG. 5 illustrates a hydraulic circuit of a brake apparatus according to a fourth embodiment.

### DESCRIPTION OF EMBODIMENTS

### First Embodiment

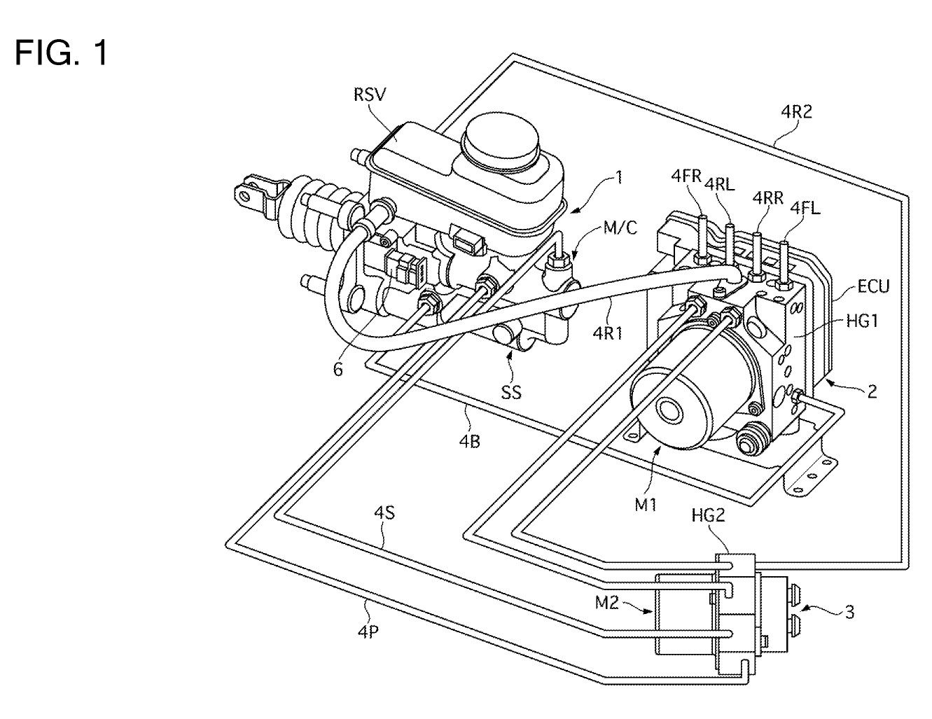

FIG. 1 is a perspective view of a brake apparatus according to a first embodiment.

The brake apparatus according to the first embodiment is mounted on an electric vehicle using a motor generator as a power source, such as a hybrid vehicle and an electric automobile. The electric automobile can carry out regenerative braking for braking the vehicle by converting motion energy of the vehicle into electric energy with use of a regenerative braking apparatus including the motor generator. The brake apparatus applies a braking force to each of wheels by supplying brake fluid to a brake activation unit mounted on each of the wheels to generate a brake hydraulic pressure. The brake apparatus includes a master cylinder unit 1, a hydraulic control unit 2, and a second pump unit 3. The master cylinder unit 1 and the hydraulic control unit 2 are connected to each other via a primary pipe (a hydraulic circuit) 4P, a secondary pipe (a hydraulic circuit) 4S, a reservoir pipe 4R1, and a backpressure chamber pipe 4B. The second pump unit 3 is provided at intermediate portions of the primary pipe 4P and the secondary pipe 4S. The master cylinder unit 1 and the second pump unit 3 are connected to each other via a reservoir pipe 4R2.

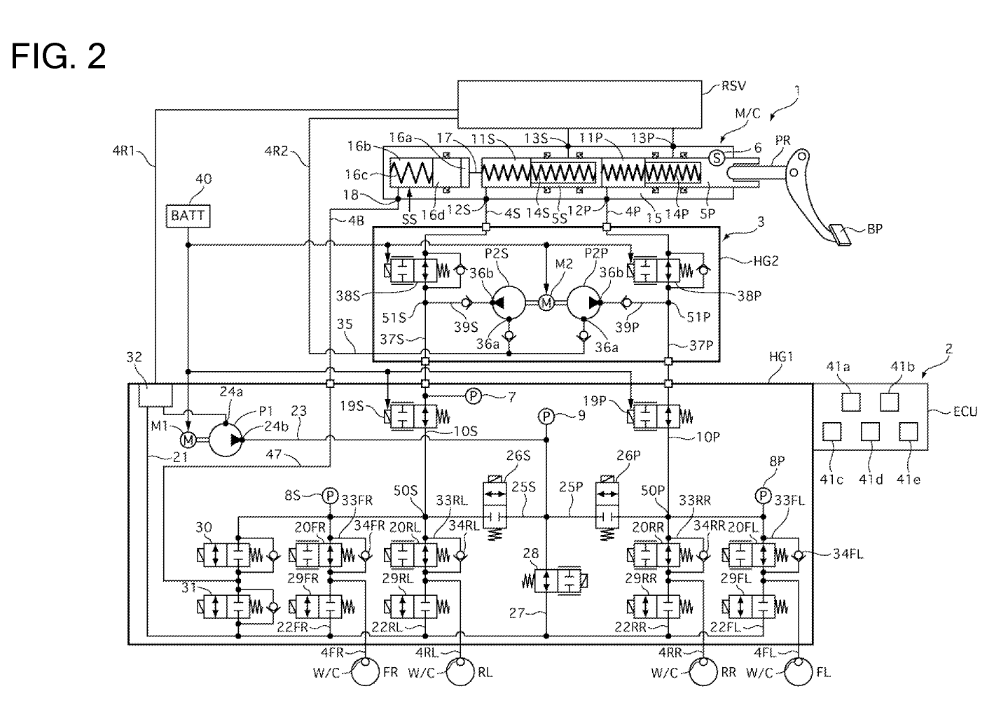

The master cylinder unit 1 includes a brake pedal BP (refer to FIG. 2), a reservoir RSV, a master cylinder M/C, and a stroke simulator SS (refer to FIG. 2). The brake pedal BP receives an input of a brake operation performed by a driver. The reservoir RSV stores the brake fluid therein. An inside of the reservoir RSV is opened to an atmospheric pressure. The master cylinder M/C is replenished with the brake fluid from the reservoir RSV, and generates a hydraulic pressure by being activated by the brake operation performed by the driver. The stroke simulator SS creates a pedal reaction force and a pedal stroke amount by an inflow of the brake fluid according to the brake operation performed by the driver. The hydraulic control unit 2 includes a plurality of electromagnetic valves, a first pump P1 (refer to FIG. 2), and an electronic control unit (a control unit) ECU. The plurality of electromagnetic valves, the first pump 1, and the electric control unit ECU are provided in a hydraulic control unit housing (a first housing) HG1. The plurality of electromagnetic valves is activated when the brake hydraulic pressure is generated independently of the brake operation performed by the driver. The first pump P1 pressurizes the brake fluid introduced from the reservoir RSV. The electronic control unit ECU controls activation of second pump P and second shut-off valves 38, which will be described below, in addition to the plurality of electromagnetic valves and the first pump Pl. The hydraulic control unit 2 supplies the brake fluid to the brake activation unit provided on each of the wheels via a wheel cylinder pipe 4FL, 4FR, 4RL, or 4RR.

FIG. 2 illustrates a hydraulic circuit of the brake apparatus according to the first embodiment.

The master cylinder unit 1 does not include an engine negative-pressure booster that boosts a brake operation force by utilizing an intake negative pressure generated by an engine of the vehicle. A push rod RR is rotatably connected to the brake pedal BP. The master cylinder M/C is a tandem type master cylinder. The master cylinder M/C includes a primary piston 5P connected to the push rod PP and a secondary piston 5S configured as a free piston as pistons axially displaceable according to the brake operation performed by the driver. The primary piston 5P is provided with a stroke sensor 6 that detects a stroke of the brake pedal BP.

The brake activation unit including a wheel cylinder W/C is a so-called-disk type brake unit. The brake activation unit includes a brake disk and a caliper (a hydraulic brake caliper). The brake disk is a brake rotor that rotates integrally with a tire. The caliper is disposed with a predetermined clearance generated between the caliper and the brake disk, and generates the braking force by being displaced by a wheel cylinder hydraulic pressure into contact with the brake disk. The brake apparatus includes two brake pipe systems (a primary P system and a secondary S system). For example, an X-split pipe configuration is employed as a brake piping method. The brake apparatus may employ another piping method, such as a front/rear split pipe configuration. Hereinafter, when a member provided in correspondence with the P system and a member provided in correspondence with the S system should be distinguished from each other, indices P and S will be added at the ends of the respective reference numerals.

The hydraulic control unit 2 is provided between the master cylinder unit 1 and the wheel cylinders W/C. The hydraulic control unit 2 individually controls the brake fluid to be supplied to each of the wheel cylinders W/C. The hydraulic control unit 2 can perform control of increasing the wheel cylinder hydraulic pressures with use of the hydraulic pressure generated by at least one of the first pump P1 and the second pump P2 with the master cylinder M/C and the wheel cylinders W/C out of communication with each other. Hydraulic sensors 7, 8, and 9 are provided in the hydraulic control unit housing HG1.

The first pump P1 introduces therein the brake fluid reserved in the reservoir RSV via the reservoir pipe 4R1 by being rotationally driven by a first motor M1, and discharges the brake fluid toward the wheel cylinders W/C. The first pump P1 is a high-pressure low-flow-amount type pump, such as a gear pump. The first pump P1 is used in common by both the P system and the S system. The first pump P1 is driven by the first motor M1. The first motor M1 is, for example, a brushless motor, but may be a brushed motor.

The master cylinder M/C is connected to the wheel cylinders W/C via the primary pipe 4P, the secondary pipe 4S, and oil passages (hydraulic circuits) 10, which will be described below. The master cylinder M/C can increase the wheel cylinder hydraulic pressures at a front left wheel FL and a rear right wheel RR via an oil passage 10P in the P system with use of a master cylinder hydraulic pressure generated in a primary fluid chamber 11P. At the same time, the master cylinder M/C can increase the wheel cylinder pressures at a rear left wheel RL and a front right wheel FR via an oil passage 11S in the S system with use of a master cylinder pressure generated in a secondary fluid chamber 11S. The primary piston 5P and the secondary piston 5S in the master cylinder M/C are inserted axially movably or displaceably along an inner peripheral surface of a bottomed cylindrical cylinder 15. The cylinder 15 includes a discharge port 12 and a replenishment port 13 for each of the P and S systems. The discharge port 12 is provided so as to be able to be connected to the hydraulic control unit 2 and be in communication with the wheel cylinders W/C. The replenishment port 13 is connected to the reservoir RSV and is in communication therewith. A coil spring 14P is set in the primary fluid chamber 11P in a pressed and compressed state. A coil spring 14S is set in the secondary fluid chamber 11S in a pressed and compressed state. The discharge ports 12 are constantly opened to both the fluid chambers 11P and 11S. A stroke simulator oil passage 17 is connected to the secondary fluid chamber 11S of the master cylinder M/C. The stroke simulator oil passage 17 is connected to a positive pressure chamber 16a of the stroke simulator SS. The cylinder 15 includes a backpressure chamber port 18 constantly opened to a backpressure chamber 16b of the stroke simulator SS. The backpressure chamber port 18 is connected to a backpressure chamber pipe 4B. The positive pressure chamber 16a and the backpressure chamber 16b are configured in such a manner that the brake fluid cannot be transmitted to and from each other therebetween. The stroke simulator SS includes a spring 16c in the backpressure chamber 16b, and generates the operation reaction force on the brake pedal BP according to the stroke of a piston 16d.

Next, the hydraulic circuit provided in the hydraulic control unit housing HG1 of the hydraulic control unit 2 will be described. Members corresponding to the individual wheels FL to RR will be distinguished from one another if necessary, by indices FL, RR, RL, and FR added at the ends of reference numerals thereof, respectively.

The oil passage 10P in the P system connects the primary pipe 4P and the wheel cylinders W/C on the front left wheel FL and the rear right wheel RR to each other. The oil passage 10S in the S system connects the secondary pipe 4S and the wheel cylinders W/C on the rear left wheel RL and the front right wheel FR to each other. Normally-opened first shut-off valves 19 are provided in the oil passages 10. Normally-opened pressure increase valves 20 are provided on a wheel cylinder W/C side in the oil passages 10 with respect to the first shut-off valves 19 in correspondence with each of the wheels. An intake oil passage 21 connects a fluid pool 32 provided at an intake portion 24a of the first pump P1 and pressure reduction oil passages 22, which will be described below, to each other. A discharge oil passage (a first discharge oil passage) 23 connects portions in the oil passages 10 between the first shut-off valves 19 and the pressure increase valves 20, and a discharge portion 24b of the first pump P1 to each other. A discharge oil passage (the first discharge oil passage) 25P connects a downstream side of the discharge oil passage 23 and the oil passage 10P in the P system to each other. A connection position 50P where the oil passage 10P is connected to the discharge oil passage 25P is a connection position where the oil passage 10P is connected to the discharge portion 24b of the first pump Pl. A normally-closed primary communication valve 26P is provided in the discharge oil passage 25P. A discharge oil passage (the first discharge oil passage) 25S connects the downstream side of the discharge oil passage 23 and the oil passage 10S in the S system to each other. A connection position 50S where the oil passage 10S is connected to the discharge oil passage 25S is a connection position where the oil passage 10S is connected to the discharge portion 24b of the first pump Pl. A normally-closed secondary communication valve 26S is provided in the discharge oil passage 25S. A first pressure reduction oil passage 27 connects a portion between the discharge oil passage 25P and the discharge oil passage 25S, and the intake oil passage 21 to each other. A normally-opened pressure adjustment valve 28 is provided in the first pressure reduction oil passage 27. The second pressure reduction oil passages 22 connect the wheel cylinder W/C side of the oil passages 10 with respect to the pressure increase valves 20, and the intake oil passage 21 to each other. Normally-closed pressure reduction valves 29 are provided in the pressure reduction oil passages 22.

A second simulator oil passage 47 connects the backpressure chamber pipe 4B and a portion in the oil passage 10S between the first shut-off valve 19S and the pressure increase valves 20RL and 20FR, and the intake oil passage 21 to each other via a stroke simulator IN valve 30 and a stroke simulator OUT valve 31, respectively.

In the first pump P1, the fluid pool 32 is provided at a portion where the reservoir pipe 4R1 is connected to the intake oil passage 21 of the first pump Pl. The discharge oil passages 25P and 25S form communication passages connecting the oil passage 10P in the P system and the oil passage 10S in the S system to each other. The first pump P1 is connected to the wheel cylinders W/C via the above-described communication passages (the discharge oil passages 25P and 25S) and the oil passages 10P and 10S. The first shut-off valves 19, the pressure increase valves 20, the pressure adjustment valve 28, and the pressure reduction valves 29 are each a proportional control valve, an opening degree of which is adjusted according to a current supplied to a solenoid. The other valves are each an ON/OFF valve, opening/closing of which is controlled to be switched between two values, i.e., switched to be either opened or closed.

Bypass oil passages 33 are provided in the oil passages 10 in parallel with the pressure increase valves 20. A check valve 34 is provided in each of the bypass oil passages 33. The check valve 34 permits only a flow of the brake fluid from the wheel cylinder W/C side to the master cylinder M/C side. The hydraulic sensor 7 is provided on the master cylinder M/C side of the oil passages 10 with respect to the first shut-off valves 19. The hydraulic sensor 7 detects a hydraulic pressure at this portion (a hydraulic pressure in the stroke simulator SS, and the master cylinder pressure). Hydraulic sensors 8 are provided between the first shut-off valves 19 and the pressure increase valves 20 in the oil passages 10. The hydraulic sensors 8 each detect a hydraulic pressure at this portion (the wheel cylinder hydraulic pressure). A hydraulic sensor 9 is provided between the discharge oil passages 25 and the communication valves 26. The hydraulic sensor 9 detects a hydraulic pressure at this portion (a discharge pressure of the pump).

The second pump unit 3 includes second pump P2. The second pump P2 is provided in a second pump housing (a second housing) HG2. The second pump P2 is provided for the P system and the S system, respectively. The second pump P2 introduces therein the brake fluid reserved in the reservoir RSV via the reservoir pipe 4R2 by being rotationally driven by a second motor M, and discharge the brake fluid toward oil passages (hydraulic circuits) 37 formed in the second pump housing HG2. The oil passages 37 are provided at intermediate positions of the primary pipe 4P and the secondary pipe 4S. The second pump P2 is a low-pressure high-flow-amount type pump, such as a gear pump. The second pump P2 provides a larger inherent discharge amount, which is a discharge amount per rotation, and a larger discharge amount per unit time than the first pump P1. The second pump P2 is driven by the single second motor M2. The second motor M2 is, for example, a brushless motor, but may be a brushed motor. The intake oil passage 35 is provided in the second pump housing HG2. The intake oil passage 35 connects the reservoir pipe 4R2 and intake portions 36a of the second pump P2 to each other. Normally-opened second shut-off valves 38 are provided in the oil passages 37. The second shut-off valves 38 are provided in the second pump housing HG2. The second shut-off valves 38 are each a proportional control valve, an opening degree of which is adjusted according to a current supplied to a solenoid. Discharge oil passages (a second discharge oil passage) 39 are provided in the second pump housing HG2. The discharge oil passages 39 connect the oil passages 37 and discharge portions 36b of the second pump P2 to each other. Connection positions 51 where the oil passages 37 are connected to the discharge oil passages 39 are connection positions where the oil passages 37 are connected to the discharge portions 36b of the second pump P2.

Detection values of the stroke sensor 6 and each of the hydraulic sensors 7, 8, and 9, and information regarding a running state (each wheel speed, a lateral acceleration, and the like) transmitted from the vehicle side are input to the electronic control unit ECU. The electronic control unit ECU performs boosting control of reducing a required brake operation force of the driver, automatic emergency brake (brake for reducing collision damage), adaptive cruise control, automatic brake control such as automatic driving control and electronic stability control, anti-lock brake control, regenerative cooperative brake control of controlling the wheel cylinder hydraulic pressures in cooperation with a regenerative brake by controlling an opening/closing operation of each of the electromagnetic valves and the discharge amount of each of the pumps in the hydraulic control unit 2 and the second pump unit 3 based on a built-in program. In the first embodiment, electric power is supplied from one battery 40 to the electronic control unit ECU and all of the actuators (the first motor M1, the first shut-off valves 19, the pressure increase valves 20, the communication valves 26, the pressure adjustment valve 28, the pressure reduction valves 29, the second pump P2, and the second shut-off valves 38). The battery 40 is a 14V battery.

In the hydraulic control unit 2, when all of the actuators are turned off (no electric power is supplied thereto) as illustrated in FIG. 2, the brake system connecting both the fluid chambers 11P and 11S of the master cylinder M/C and the wheel cylinders W/C to each other generates the wheel cylinder hydraulic pressures by the master cylinder hydraulic pressure generated with use of a pedal pressing force, thereby realizing pressing force brake (non-boosting control). On the other hand, when the first shut-off valves 19, the stroke simulator IN valve 30, and the stroke simulator OUT valve 31 are turned on, and the first shut-off valves 19 is controlled in valve-closing directions and the stroke simulator IN valve 30 and the stroke simulator OUT valve 31 are controlled in valve-opening directions from the state illustrated in FIG. 2, the brake system connecting the secondary hydraulic chamber 11S of the master cylinder M/C and the wheel cylinders WC to each other generates the wheel cylinder hydraulic pressures with use of the brake hydraulic pressure flowing out of the backpressure chamber 16b having a volume reducing according to a displacement of the piston 16d of the stroke simulator SS, thereby realizing (second) pressing force brake. Further, when the stroke simulator IN valve 30 is controlled in a valve-closing direction and the stroke simulator OUT valve 31 is controlled in the valve-opening direction with the first shut-off valves 19 controlled in the valve-closing directions, the brake system connecting the reservoir RSV and the wheel cylinders W/C to each other (the intake oil passage 21, the discharge oil passage 23, and the like) generates the wheel cylinder hydraulic pressures by the hydraulic pressure generated with use of the first pump P1, thereby forming a so-called brake-by-wire system capable of realizing the boosting control, the automatic brake control, the regenerative cooperative control, and the like. The brake control may be switched to the boosting control or the automatic brake control after the second pressing force brake.

Now, the brake apparatus according to the first embodiment includes the second pump unit 3 including the second pump P2 and the second shut-off valves 38. The second pump P2 introduces therein the brake fluid from the reservoir RSV, and discharge the pressurized brake fluid toward the primary pipe 4P and the secondary pipe 4S, similarly to the first pump P1. In other words, the second pump P2 is provided in parallel with the first pump P1 with respect to the hydraulic circuits (4P, 4S, 10P, and 10S) connecting the master cylinder M/C and the wheel cylinders W/C to each other. Further, the second shut-off valves 38 are provided between the first shut-off valves 19 and the master cylinder M/C. In other words, the second shut-off valves 38 are provided in series with the first shut-off valves 19 in the hydraulic circuits. Therefore, the second pump P2 and the second shut-off valves 38 can function as a standby redundant system of the first pump P1 and the first shut-off valves 19. The electronic control unit ECU controls the second shut-off valves 38 in place of the first shut-off valves 19 when a failure has occurred in the first shut-off valves 19. By this configuration, the wheel cylinder hydraulic pressures can be increased by closing the second shut-off valves 38 even if an opening failure has occurred in the first shut-off valves 19. Therefore, the brake apparatus can perform and continue the boosting control and the automatic brake control. Further, the electronic control unit ECU can increase the wheel cylinder hydraulic pressures by driving the second pump P2 when a failure has occurred in the first pump Pl. In this case, the electronic control unit ECU turns off the first shut-off valves 19 and turns on the second shut-off valves 38.

The electronic control unit ECU includes a vehicle state detection unit 41a, a target wheel cylinder hydraulic pressure calculation unit 41b, a pressing force brake control unit 41c, a boosting control unit 41d, and a boosting control switching unit 41e.

The vehicle state detection unit 41a detects whether the brake is turned on/off and also detects a sudden braking state from the detection value of the stroke sensor 6. The vehicle state detection unit 41a determines that the vehicle is in the sudden braking state if a speed of a change in the brake pedal stroke exceeds a predetermined speed threshold value, or a difference between a target wheel cylinder hydraulic pressure calculated by the target wheel cylinder hydraulic pressure calculation unit 41b and a previous value of the target wheel cylinder hydraulic pressure exceeds a predetermined difference threshold value.

The target wheel cylinder hydraulic pressure calculation unit 41b calculates the target wheel cylinder hydraulic pressure. More specifically, the target wheel cylinder hydraulic pressure calculation unit 41b calculates the target wheel cylinder hydraulic pressure that realizes a predetermined boosting rate, i.e., an ideal characteristic about a relationship between the pedal stroke and a brake hydraulic pressure requested by the driver (a vehicle deceleration requested by the driver) based on the stroke of the brake pedal BP. At the time of the regenerative cooperative brake control, the target wheel cylinder hydraulic pressure calculation unit 41b calculates the target wheel cylinder hydraulic pressure by subtracting a value acquired by converting an executed regenerative braking force into a hydraulic pressure from the brake hydraulic pressure requested by the driver. In the automatic brake control, the target wheel cylinder hydraulic pressure calculation unit 41b calculates the target wheel cylinder hydraulic pressure for each of the wheels that can realize a desired vehicle motion state based on a detected vehicle running state and a detected surrounding state.

The pressing force brake control unit 41c is configured to prohibit the stroke simulator SS from functioning by controlling the shut-off valves 19 in valve-opening directions, the stroke simulator IN valve 30 in the valve-closing direction, and the stroke simulator OUT valve 31 in the valve-closing direction, thereby realizing the pressing force brake that generates the wheel cylinder hydraulic pressures with use of the master cylinder pressure.

The boosting control unit 41d controls the shut-off valves 19 in the valve-closing directions to thus make the second hydraulic control unit 2 ready to generate the wheel cylinder hydraulic pressures by the first pump P1, thereby performing the boosting control. The boosting control unit 41d controls each of the actuators, thereby realizing the target wheel cylinder hydraulic pressure. Further, the electric control unit ECU controls the stroke simulator IN valve 31 in the valve-closing direction and controls the stroke simulator IN valve 30 in the valve-opening direction, thereby causing the stroke simulator SS to function.

The boosting control switching unit 41e controls the activation of the master cylinder M/C to switch the pressing force brake and the boosting control based on the calculated target wheel cylinder hydraulic pressure. More specifically, when a start of the brake operation is detected by the brake state detection unit 41a, the boosting control switching unit 41e causes the pressing force brake generation unit 41c to generate the wheel cylinder hydraulic pressures if the calculated target wheel cylinder hydraulic pressure can be achieved only by the pressing force brake. On the other hand, the boosting control switching unit 41e causes the boosting control unit 41d to generate the wheel cylinder hydraulic pressures if the target wheel cylinder hydraulic pressure calculated at the time of the operation of pressing the brake cannot be achieved only by the pressing force brake. Further, the boosting control switching unit 41e can also cause the second pressing force brake to generate the wheel cylinder hydraulic pressures, and, after that, switch the brake control so as to generate the wheel cylinder hydraulic pressures by the boosting control unit 41d, when the sudden braked state is detected by the vehicle state detection unit 41a.

In the first embodiment, the brake apparatus turns on the second pump P2 in addition to the first pump P1 when the sudden braking state is detected, with an attempt to improve responsiveness of increasing the pressures in the wheel cylinders W/C at the time of the sudden braking. Further, the brake apparatus turns on the second shut-off valves 38 instead of the first shut-off valves 19 when turning on the second pump P2.

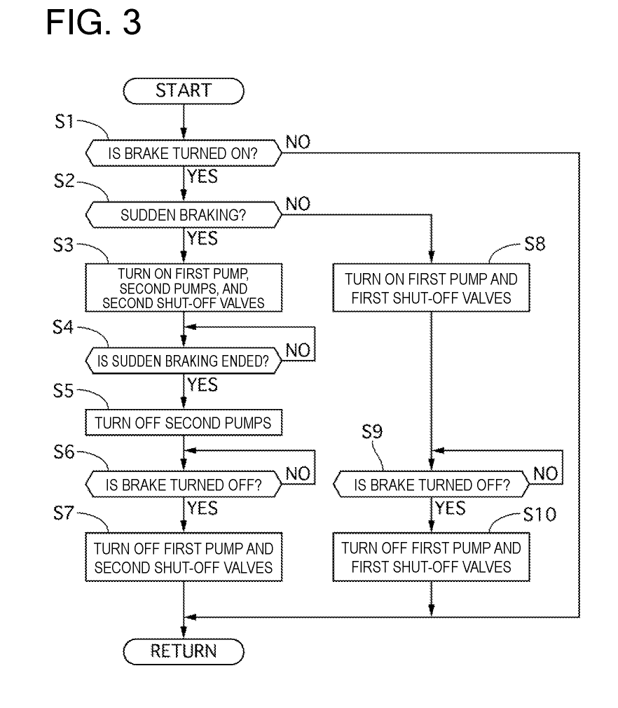

FIG. 3 is a flowchart illustrating a flow of the boosting control by the boosting control unit 41d according to the first embodiment.

In step S1, the boosting control unit 41d determines whether turning on the brake is detected by the vehicle state detection unit 41a. If the boosting control unit 41d determines YES, the processing proceeds to step S2. If the boosting control unit 41d determines NO, the processing proceeds to RETURN.

In step S2, the boosting control unit 41d determines whether the sudden braking state is detected by the vehicle state detection unit 41a. If the boosting control unit 41d determines YES, the processing proceeds to step S3. If the boosting control unit 41d determines NO, the processing proceeds to step S8.

In step S3, the boosting control unit 41d turns on the first pump P1, the second pump P2, and the second shut-off valves 38.

In step S4, the boosting control unit 41d determines that an end of the sudden braking state is detected by the vehicle state detection unit 41a. If the boosting control unit 41d determines YES, the processing proceeds to step S5. If the boosting control unit 41d determines NO, step S4 is repeated.

In step S5, the boosting control unit 41d turns off the second pump P2.

In step S6, the boosting control unit 41d determines that turning off the brake is detected by the vehicle state detection unit 41a. If the boosting control unit 41d determines YES, the processing proceeds to step S7. If the boosting control unit 41d determines NO, step S6 is repeated.

In step S7, the boosting control unit 41d turns off the first pump P1 and the second shut-off valves 38.

In step S8, the boosting control unit 41d turns on the first pump P1 and the first shut-off valves 19.

In step S9, the boosting control unit 41d determines whether turning off the brake is detected by the vehicle state detection unit 41a. If the boosting control unit 41d determines YES, the processing proceeds to step S10. If the boosting control unit 41d determines NO, step S9 is repeated.

In step S10, the boosting control unit 41d turns off the first pump P1 and the first shut-off valves 19.

In this manner, the boosting control unit 41d controls the first shut-off valves 19 in the valve-closing directions and drives only the first pump P1 at the time of a non-sudden braking state. On the other hand, the boosting control unit 41d controls the second shut-off valves 38 in the valve-closing directions and drives both the first pump P1 and the second pump P2 at the time of the sudden braking, and, after that, stops the second pump P2 and drives only the first pump P1 when the vehicle returns to the non-sudden braking state.

Now, the automatic emergency brake, which detects an obstacle existing in an advancing direction of the vehicle on which the brake apparatus is mounted and suddenly slows down this vehicle when approaching this obstacle, should generate a large braking force in a short time period, and therefore is required to achieve high responsiveness of increasing the pressures in the wheel cylinders. Satisfying this requirement with use of one pump requires a high-pressure high-flow-amount type pump, but the high-pressure high-flow-amount type pump requires a high-output high-current motor. However, mounting the high-output high-current motor raises a drawback such as consumption of the battery and an increase in cost of an electric power source harness especially in the vehicle that performs the automatic brake control of constantly activating the pump, such as the adaptive cruise control and the automatic driving.

Focusing on a relationship between the hydraulic pressure in the wheel cylinder and the fluid amount, the disk type brake activation unit consumes a large fluid amount in a region since a start of the supply of the brake fluid until the clearance between the brake disk and the brake pad is closed up and then the braking force starts to be generated on full scale. In other words, the hydraulic pressure increases at a low gradient with respect to an increase in the fluid amount in a low-pressure region, which is a region until the clearance is closed up compared to a high-pressure region, which is a region after the clearance is closed up. This means that a larger fluid amount is consumed to generate the hydraulic pressure in the low-pressure region compared to the high-pressure region, and therefore the hydraulic pressure does not easily increase even if the same fluid amount is supplied. In other words, the responsiveness of increasing the pressures in the wheel cylinders can be effectively improved if the clearance can be quickly closed up in the low-pressure region where the large fluid amount is consumed. Especially, in the electric vehicle performing the regenerative braking, the clearance tends to be set to a relatively large distance to prevent or reduce deterioration of fuel efficiency along with a friction between the brake disk and the brake pad. Therefore, in the electric vehicle, the responsiveness of increasing the pressures can be noticeably improved if the clearance can be quickly closed up. The same also applies to a drum type brake activation unit.

Therefore, the brake apparatus according to the first embodiment increases the pressures in the wheel cylinders W/C with use of only the first pump P1 in a region in which the brake is used in a normal manner (at the time of the non-sudden braking) while increasing the wheel cylinder hydraulic pressures by activating the second pump P2 in addition to the first pump P1 at the time of the sudden braking. At the time of the non-sudden braking, the high responsiveness is unnecessary and therefore the required braking force can be secured only by the discharge amount of the high-pressure low-flow-amount type first pump P1. On the other hand, at the time of the sudden braking, the brake apparatus activates the low-pressure high-flow-amount type second pump P2 in addition to the first pump p1, thereby succeeding in quickly closing up the clearance in the low-pressure region where the large fluid amount is consumed, thus increasing the responsiveness of increasing the pressure. The second pump P2 does not support the high-pressure region, but the required responsiveness can be secured only by the first pump P1 because the consumed flow amount is small in the high-pressure region. Further, even when the automatic brake control, which constantly activates the pump, such as the adaptive cruise control and the automatic driving, is performed, the second pump P2 is activated only at the time of the sudden braking, which means that only the first pump P1 is constantly activated. The first pump P1 is the high-pressure low-flow-amount type pump, and therefore does not raise the drawback such as the consumption of the battery 40 and the increase in the cost of the electric power source harness. In other words, the brake apparatus according to the first embodiment can secure the responsiveness of increasing the pressures in the wheel cylinders W/C at the time of the sudden braking while preventing or cutting down the consumption of the battery and the increase in the cost of the harness.

The first embodiment brings about the following advantageous effects.

(1) The brake apparatus includes the hydraulic circuit (the primary pipe 4P, the secondary pipe 4S, the oil passages 10, and the oil passage 37) connecting the master cylinder M/C configured to pressurize the brake fluid according to the brake operation performed by the driver and the wheel cylinder W/C configured to apply the braking force to each of the wheels FL, FR, RL, and RR according to the brake hydraulic pressure, the first pump P1 configured to supply the brake fluid to the hydraulic circuit, the first shut-off valve 19 provided between the connection position 50 where the hydraulic circuit is connected to the discharge portion 24b of the first pump P1 and the master cylinder M/C, and the second shut-off valve 38 provided between the first shut-off valve 19 and the master cylinder M/C.

Therefore, even when the opening failure has occurred in the first shut-off valve 19, the brake apparatus can acquire the desired brake hydraulic pressure by closing the second shut-off valve 38 and driving the first pump Pl.

(2) The brake apparatus according to the above-described item (1) further includes the second pump P2 provided in the hydraulic circuit and configured to supply the brake fluid to the wheel cylinder W/C in parallel with the first pump P1. The second shut-off valve 38 is provided between the connection position 51 where the hydraulic circuit is connected to the discharge portion 36b of the second pump P2, and the master cylinder M/C.

Therefore, even when the opening failure has occurred in the first shut-off valve 19, the brake apparatus can acquire the desired brake hydraulic pressure by closing the second shut-off valve 38 and driving at least one of the first pump P1 and the second pump P2. Further, even when the failure has occurred in the first pump Pl, the brake apparatus can acquire the desired brake hydraulic pressure by driving the second pump P2.

(3) In the brake apparatus according to the above-described item (2), the second shut-off valve 38 is controlled in the valve-closing direction when at least the second pump P2 is activated.

Therefore, the brake apparatus can prevent the brake fluid discharged from the second pump P2 from flowing toward the master cylinder M/C side by controlling the second shut-off valve 38 in the valve-closing direction, thereby increasing the wheel cylinder hydraulic pressure.

(4) The brake apparatus according to the above-described item (3) further includes the electronic control unit ECU configured to control the first pump P1, the second pump P2, the first shut-off valve 19 and/or the second shut-off valve 38 according to the result of the detection by the vehicle state detection unit 41a configured to detect the vehicle state (the sudden braking or the non-sudden braking).

Therefore, the brake apparatus can arbitrarily control each of the pumps P1 and P2 and each of the shut-off valves 19 and 38 according to the vehicle state.

(5) In the brake apparatus according to the above-described item (4), the second pump P2 discharges the larger inherent discharge amount than the first pump P1.

Therefore, the brake apparatus can improve the responsiveness of increasing the pressure in the wheel cylinder W/C by supplying the brake fluid with use of the second pump P2.

(6) In the brake apparatus according to the above-described item (4), the second pump P2 discharges the larger discharge amount per unit time than the first pump P1.

Therefore, the brake apparatus can improve the responsiveness of increasing the pressure in the wheel cylinder W/C by supplying the brake fluid with use of the second pump P2.

(7) In the brake apparatus according to the above-described item (4), the electronic control unit ECU controls the second shut-off valve 38 in the valve-closing direction and drives both the first pump P1 and the second pump P2 when the sudden braking is detected by the vehicle state detection unit 41a.

Therefore, the brake apparatus can increase the responsiveness of increasing the pressure in the wheel cylinder W/C at the time of the sudden braking, thereby further reliably acquiring the required braking force.

(8) The brake apparatus according to the above-described item (2) further includes the first discharge oil passage (the discharge oil passage 23 and the discharge oil passage 25) connecting the discharge portion 24b of the first pump P1 and the hydraulic circuit therebetween, and the second discharge oil passage 39 connecting the portion between the connection position 50 where the first discharge oil passage is connected to the hydraulic circuit and the master cylinder M/C, and the discharge portion 36b of the second pump P2 to each other.

Therefore, the oil passage can be simplified.

(9) In the brake apparatus according to the above-described item (2), the first shut-off valve 19 is provided between the connection position 50 where the hydraulic circuit is connected to the discharge portion 24b of the first pump P1 and the connection position 51 where the hydraulic circuit is connected to the discharge portion 36b of the second pump P2. The electronic control unit ECU controls at least one of the first shut-off valve 19 and the second shut-off valve 38 in the valve-closing direction, drives the first pump P1, and refrains from driving the second pump P2 if the sudden braking is not detected by the vehicle state detection unit 41a.

Therefore, at the time of the non-sudden braking, which does not require the high responsiveness, the brake apparatus can reduce the electric power consumption by driving only the first pump P1.

(10) In the brake apparatus according to the above-described item (2), the first pump P1 and the first shut-off valve 19 are disposed in the hydraulic control unit housing HG1. The second pump P2 and the second shut-off valve 38 are disposed in the second pump housing HG2 provided differently from the hydraulic control unit housing HG1.

Therefore, the brake apparatus allows the individual housings to reduce in size and be disposed separately from each other, thereby succeeding in improving flexibility of vehicle mountability compared to disposing the both pumps P1 and P2 and the both shut-off valves 19 and 38 in one housing.

(11) The brake apparatus includes the hydraulic circuit (the primary pipe 4P, the secondary pipe 4S, and the oil passages 10) connecting the master cylinder M/C configured to pressurize the brake fluid according to the brake operation performed by the driver and the wheel cylinder W/C configured to apply the braking force to each of the wheels FL, FR, RL, and RR according to the brake hydraulic pressure to each other, the first discharge oil passage (the discharge oil passage 23 and the discharge oil passages 25) connected to the hydraulic circuit, the first pump P1 configured to supply the brake fluid to the wheel cylinder W/C via the first discharge oil passage, the second discharge oil passage 39 connected to the hydraulic circuit on the master cylinder M/C side with respect to the connection position 50 where the first discharge oil passage is connected to the hydraulic circuit, the second pump P2 configured to supply the brake fluid to the wheel cylinder W/C via the second discharge oil passage 39, the first shut-off valve 19 provided between the connection position 50 where the hydraulic circuit is connected to the first discharge oil passage and the connection positon 51 where the hydraulic circuit is connected to the second discharge oil passage 39, the second shut-off valve 38 provided between the second discharge oil passage 39 in the hydraulic circuit and the master cylinder M/C, and the electronic control unit ECU configured to control each of the shut-off valves 19 and 38 according to the activation state of each of the pumps P1 and P2.

Therefore, even when the opening failure has occurred in the first shut-off valve 19, the brake apparatus can acquire the desired brake hydraulic pressure by closing the second shut-off valve 38 and driving at least one of the first pump P1 and the second pump P2. Further, even when the failure has occurred in the first pump P1, the brake apparatus can acquire the desired brake hydraulic pressure by driving the second pump P2.

(12) The brake apparatus includes the hydraulic circuit (the primary pipe 4P, the secondary pipe 4S, and the oil passages 10) connecting the master cylinder M/C configured to pressurize the brake fluid according to the brake operation performed by the driver and the wheel cylinder W/C configured to apply the braking force to each of the wheels FL, FR, RL, and RR according to the brake hydraulic pressure to each other, the first discharge oil passage (the discharge oil passage 23 and the discharge oil passage 25) connected to the hydraulic circuit, the first pump P1 configured to supply the brake fluid to the wheel cylinder W/C via the first discharge oil passage, the second discharge oil passage 39 connected to the hydraulic circuit on the master cylinder M/C side with respect to the connection position 50 where the first discharge oil passage is connected to the hydraulic circuit, the second pump P2 configured to supply the brake fluid to the wheel cylinder W/C via the second discharge oil passage 39 and configured to discharge the larger inherent discharge amount than the first pump P1, the first shut-off valve 19 provided between the connection position 50 where the hydraulic circuit is connected to the first discharge oil passage and the connection position 51 where the hydraulic circuit is connected to the second discharge oil passage 39, the second shut-off valve 38 provided between the connection position 51 where the hydraulic circuit is connected to the second discharge oil passage 39 and the master cylinder M/C, and the electronic control unit ECU configured to selectively control each of the shut-off valves 19 and 38.

Therefore, even when the opening failure has occurred in the first shut-off valve 19, the brake apparatus can acquire the desired brake hydraulic pressure by closing the second shut-off valve 38 and driving at least one of the first pump P1 and the second pump P2. Further, even when the failure has occurred in the first pump P1, the brake apparatus can acquire the desired brake hydraulic pressure by driving the second pump P2. Further, the brake apparatus can reduce the electric power consumption by selectively using the first shut-off valve 19 and the second shut-off valve 38.

### Second Embodiment

Next, a second embodiment will be described. A basic configuration thereof is similar to the first embodiment, and therefore only differences will be described below. The electronic control unit (control unit) ECU according to the second embodiment controls the first pump P1 and the second pump P2, and the first shut-off valves 19 and the second shut-off valves 38 according to a vehicle rank at the time of the boosting control, the automatic brake control, and the regenerative cooperative control. More specifically, the boosting control unit 41d of the electronic control unit ECU controls the first shut-off valves 19 in the valve-closing directions and drives the first pump P1 if the vehicle rank is equal to or lower than a preset vehicle rank. On the other hand, the boosting control unit 41d controls the second shut-off valves 38 in the valve-closing directions and drive the first pump P1 and the second pump P2 if the vehicle rank is higher than the preset vehicle rank. Then, for example, a total length of the vehicle, a wheelbase, an engine capacity, and/or the like can be used as parameters of vehicle specifications indicating the vehicle rank.

The second embodiment brings about the following advantageous effects.

(13) The brake apparatus according to the above-described item (2) further includes the electronic control unit ECU configured to control the first pump P1 and/or the second pump P2, and the first shut-off valve 19 and/or the second shut-off valve 38 according to the vehicle rank.

Therefore, the brake apparatus can arbitrarily control the first pump P1, the second pump P2, the first shut-off valve 19, and the second shut-off valve 38 according to the specifications of the vehicle.

(14) In the brake apparatus according to the above-described item (13), the electronic control unit ECU controls the second shut-off valve 38 in the valve-closing direction and drives both the first pump P1 and the second pump P2 if the vehicle rank is higher than the preset vehicle rank.

Therefore, the brake apparatus can further reliably acquire the required braking force by driving the first pump P1 and the second pump P2 if the vehicle rank is high.

### Third Embodiment

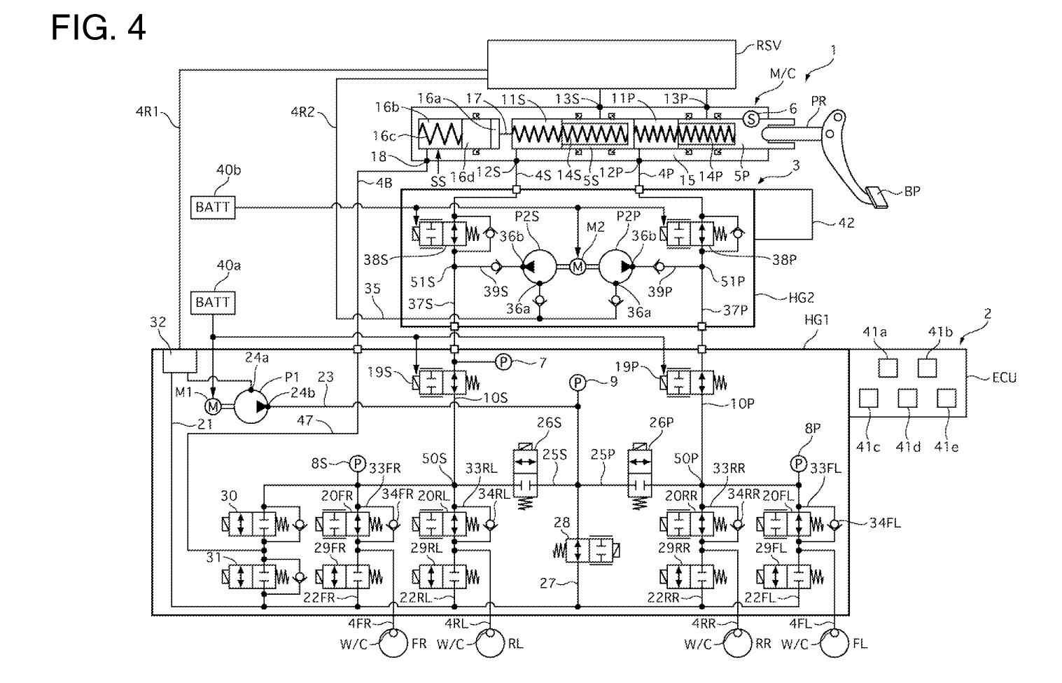

Next, a third embodiment will be described. A basic configuration thereof is similar to the first embodiment, and therefore only differences will be described below. FIG. 4 illustrates a hydraulic circuit of a brake apparatus according to the third embodiment.

The brake apparatus according to the third embodiment includes two batteries 40a and 40b. The first battery (a first electric power source) 40a supplies electric power to each of the actuators of the hydraulic control circuit 2 (the first motor M1, the first shut-off valves 19, the pressure increase valves 20, the communication valves 26, the pressure adjustment valve 28, and the pressure reduction valves 29). The second battery (a second electric power source) 40b supplies electric power to each of the actuators of the second pump unit 3 (the second pump P2 and the second shut-off valves 38). Both of the batteries 40a and 40b are 14 batteries. Further, the second pump unit 3 includes an electronic control unit 42. The electronic control unit 42 receives supply of electric power from the second battery 40b. The electronic control unit 42 increases the wheel cylinder hydraulic pressures by controlling the second pump P2 and the second shut-off valves 38 if the electronic control unit ECU has some failure therein and becomes unable to control the first pump P1 and the first shut-off valves 19.

The third embodiment brings about the following advantageous effects.

(15) The brake apparatus according to the above-described item (2) further includes the first battery 40a configured to supply the electric power to the first shut-off valve 19, and the second battery 40b configured to supply the electric power to the second shut-off valve 38.

Therefore, even when a failure has occurred in one of the batteries, the brake apparatus can increase the wheel cylinder hydraulic pressure by controlling the pump and the shut-off valve receiving the supply of the electric power from the other normal battery.

### Fourth Embodiment

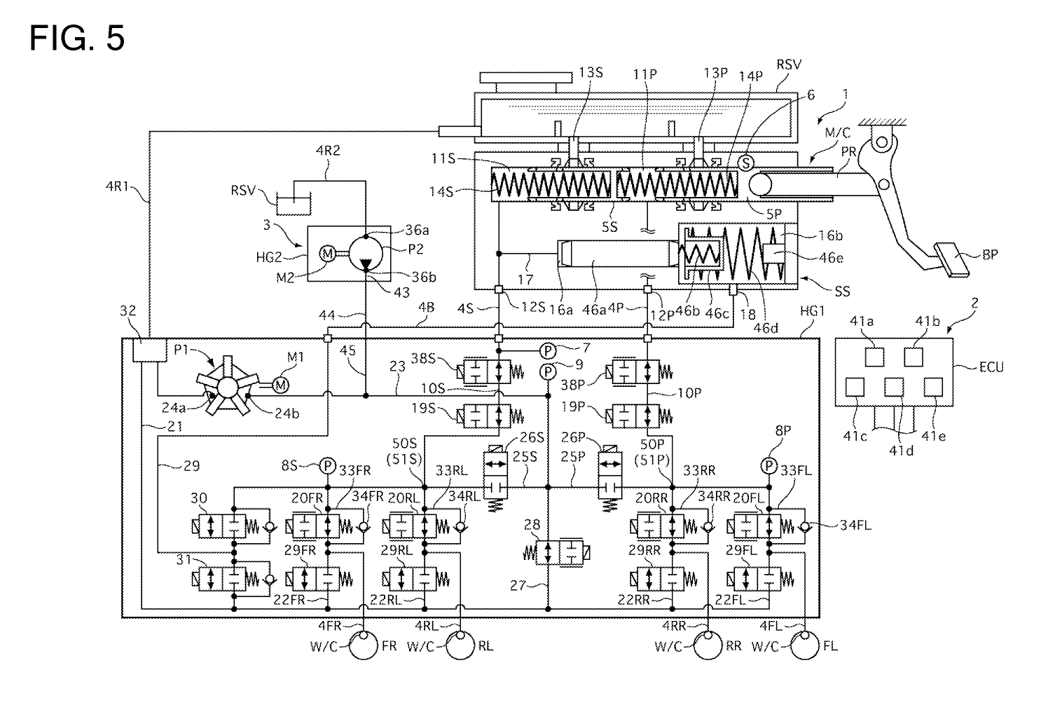

Next, a fourth embodiment will be described. A basic configuration thereof is similar to the first embodiment, and therefore only differences will be described below. FIG. 5 illustrates a hydraulic circuit of a brake apparatus according to the fourth embodiment.

In the fourth embodiment, the second shut-off valves 38 are provided in the hydraulic control unit 2. The second shut-off valves 38 are disposed on the master cylinder M/C side of the oil passages 10 with respect to the first shut-off valves 19. Further, the discharge portion 36b of the second pump P2 is connected to the discharge oil passage 23 via a discharge oil passage 43, a pipe 44, and a discharge oil passage 45. In other words, in the fourth embodiment, the connection positions 50 where the oil passages 10 are connected to the discharge portion 24b of the first pump P1, and the connection positions 51 where the oil passages 10 are connected to the discharge portion 36b of the second pump P2 match each other. The discharge oil passage 43 is formed in the second pump housing HG2, and the discharge oil passage 45 is formed in the hydraulic control unit housing HG1. The pipe 44 connects the discharge oil passage 43 and the discharge oil passage 45 to each other. The first pump P1 is a plunger pump including five plungers that is excellent in terms of a noise and vibration performance

The stroke simulator SS according to the fourth embodiment includes a piston 46a , a first spring 46b, a retainer member 46c, a second spring 46d, and a damper 46e. The piston 46a divides the inside the stroke simulator SS into the two chambers (the positive pressure chamber 16a and the backpressure chamber 16b), and is provided axially displaceably in the chambers. The first spring 46b biases the piston 46a toward the positive pressure chamber 16a side (a direction for reducing a volume of the positive pressure chamber 16a and increasing a volume of the backpressure chamber 16b). The retainer member 46c holds the first spring 46b. The second spring 46d constantly biases the retainer member 46c toward the positive pressure chamber 16a side. A biasing force of the second spring 46d is stronger than a biasing force of the first spring 46b. The damper 46e is a cushion member for generating a feeling as if the pedal reaches a bottom.

The brake apparatus according to the fourth embodiment can also acquire the desired brake hydraulic pressure by controlling the second shut-off valves 38 in the valve-closing directions and activating at least one of the first pump P1 and the second pump P2 when the opening failure has occurred in the first shut-off valves 19.

### Fifth Embodiment

Next, a fifth embodiment will be described. A basic configuration thereof is similar to the first embodiment, and therefore only differences will be described below. The electronic control unit ECU (control unit) according to the fifth embodiment increases the pressures in the wheel cylinders W/C with use of only the second pump P2 in the low-pressure region and increases the pressures in the wheel cylinders W/C with use of only the first pump P1 in the high-pressure region at the time of the sudden braking. Therefore, according to the fifth embodiment, the brake apparatus can reduce the electric power consumption by selectively using the first pump P1 and the second pump P2.

In the following description, technical ideas other than the inventions set forth in the claims that are recognizable from the embodiments will be described.

(16) In the brake apparatus according to claim 14, the control unit controls each of the pumps and each of the shut-off valves according to a result of detection by a vehicle state detection unit configured to detect a vehicle state.

Therefore, the brake apparatus can arbitrarily control each of the pumps and each of the shut-off valves and according to the vehicle state.

(17) In the brake apparatus according to the above-described item (16), the second pump discharges a larger inherent discharge amount than the first pump.

Therefore, the brake apparatus can improve the responsiveness of increasing the pressure in the wheel cylinder by supplying the brake fluid with use of the second pump.

(18) In the brake apparatus according to the above-described item (16), the control unit controls the second shut-off valve in a valve-closing direction and drives both the first pump and the second pump when sudden braking is detected by the vehicle state detection unit.

Therefore, the brake apparatus can increase the responsiveness of increasing the pressure in the wheel cylinder at the time of the sudden braking, thereby further reliably acquiring the required braking force.

(19) The brake apparatus according to claim 14 further includes a first electric power source configured to supply electric power to the first pump and the first shut-off valve, and a second electric power source configured to supply electric power to the second pump and the second shut-off valve.

Therefore, even when a failure has occurred in one of the electric power sources, the brake apparatus can increase the wheel cylinder hydraulic pressure by controlling the pump and the shut-off valve receiving the supply of the electric power from the other normal electric power source.

Having described merely several embodiments of the present invention, those skilled in the art will be able to easily appreciate that the embodiments described as the examples can be modified or improved in various manners without substantially departing from the novel teachings and advantages of the present invention. Therefore, such modified or improved embodiments are intended to be also contained in the technical scope of the present invention. The above-described embodiments may also be arbitrarily combined.

The present application claims priority under the Paris Convention to Japanese Patent Application No. 2015-125416 filed on Jun. 23, 2015. The entire disclosure of Japanese Patent Application No. 2015-125416 filed on Jun. 23, 2015 including the specification, the claims, the drawings, and the abstract is incorporated herein by reference in its entirety.

### REFERENCE SIGN LIST

ECU electronic control unit (control unit)
HG1 hydraulic control unit housing (first housing)
HG2 second pump housing (second housing)
M/C master cylinder
P1 first pump
P2 second pump
W/C wheel cylinder
4P primary pipe (hydraulic circuit)
4S secondary pipe (hydraulic circuit)
10 oil passage (hydraulic circuit)
19 first shut-off valve
23 discharge oil passage (first discharge oil passage)
24b discharge portion
25 discharge oil passage (first discharge oil passage)
36b discharge portion
37 oil passage (hydraulic circuit)
38 second shut-off valve
39 discharge oil passage (second discharge oil passage)
40a first battery (first electric power source)
40b second battery (second electric power source)
41a vehicle state detection unit
50 connection position
51 connection position

1. A brake apparatus comprising:
a hydraulic circuit that connects a master cylinder configured to pressurize brake fluid according to a brake operation performed by a driver and a wheel cylinder configured to apply a braking force to a wheel according to a brake hydraulic pressure;
a first pump configured to supply the brake fluid to the hydraulic circuit;
a first shut-off valve provided between a connection position where the hydraulic circuit is connected to a discharge portion of the first pump, and the master cylinder;
a second shut-off valve provided between the first shut-off valve and the master cylinder; and
a second pump provided in the hydraulic circuit and configured to supply the brake fluid to the wheel cylinder in parallel with the first pump,
wherein the second shut-off valve is provided between a connection portion where the hydraulic circuit is connected to a discharge portion of the second pump, and the master cylinder, and
wherein the second shut-off valve is controlled in a valve-closing direction when at least the second pump is activated.

2.-3. (canceled)

4. The brake apparatus according to claim 1, further comprising a control unit configured to control the first pump, the second pump, the first shut-off valve and/or the second shut-off valve according to a result of detection by a vehicle state detection unit configured to detect a vehicle state.

5. The brake apparatus according to claim 4, wherein the second pump discharges a larger inherent discharge amount than the first pump.

6. The brake apparatus according to claim 4, wherein the second pump discharges a larger discharge amount per unit time than the first pump.

7. The brake apparatus according to claim 4, wherein the control unit controls the second shut-off valve in a valve-closing direction and drives both the first pump and the second pump when sudden braking is detected by the vehicle state detection unit.

8. The brake apparatus according to claim 1, further comprising:
a first discharge oil passage that connects the discharge portion of the first pump and the hydraulic circuit therebetween; and
a second discharge oil passage that connects a portion between a connection position where the first discharge oil passage is connected to the hydraulic circuit and the master cylinder, and the discharge portion of the second pump to each other.

9. The brake apparatus according to claim 1, wherein the first shut-off valve is provided between the connection position where the hydraulic circuit is connected to the discharge portion of the first pump and the connection position where the hydraulic circuit is connected to the discharge portion of the second pump, and
wherein the control unit controls at least one of the first shut-off valve and the second shut-off valve in the valve-closing direction, drives the first pump, and refrains from driving the second pump if sudden braking is not detected by the vehicle state detection unit.

10. The brake apparatus according to claim 1, wherein the first pump and the first shut-off valve are disposed in a first housing, and
wherein the second pump and the second shut-off valve are disposed in a second housing provided differently from the first housing.

11. A brake apparatus comprising:
a hydraulic circuit that connects a master cylinder configured to pressurize brake fluid according to a brake operation performed by a driver and a wheel cylinder configured to apply a braking force to a wheel according to a brake hydraulic pressure;
a first pump configured to supply the brake fluid to the hydraulic circuit;
a first shut-off valve provided between a connection position where the hydraulic circuit is connected to a discharge portion of the first pump, and the master cylinder;
a second shut-off valve provided between the first shut-off valve and the master cylinder; and
a second pump provided in the hydraulic circuit and configured to supply the brake fluid to the wheel cylinder in parallel with the first pump,
wherein the second shut-off valve is provided between a connection portion where the hydraulic circuit is connected to a discharge portion of the second pump, and the master cylinder, and
wherein the brake apparatus according to claim 2, further comprises a control unit configured to control the first pump and/or the second pump, and the first shut-off valve and/or the second shut-off valve according to a vehicle rank.

12. The brake apparatus according to claim 11, wherein the control unit controls the second shut-off valve in a valve-closing direction and drives both the first pump and the second pump if the vehicle rank is higher than a preset vehicle rank.

13. The brake apparatus according to claim 1, further comprising:
a first electric power source configured to supply electric power to the first shut-off valve; and
a second electric power source configured to supply electric power to the second shut-off valve.

14. A brake apparatus comprising:
a hydraulic circuit that connects a master cylinder configured to pressurize brake fluid according to a brake operation performed by a driver and a wheel cylinder configured to apply a braking force to a wheel according to a brake hydraulic pressure;
a first discharge oil passage connected to the hydraulic circuit;
a first pump configured to supply the brake fluid to the wheel cylinder via the first discharge oil passage;
a second discharge oil passage connected to the hydraulic circuit on one side closer to the master cylinder with respect to a connection position where the first discharge oil passage is connected to the hydraulic circuit;
a second pump configured to supply the brake fluid to the wheel cylinder via the second discharge oil passage;
a first shut-off valve provided between the connection position where the hydraulic circuit is connected to the first discharge oil passage, and a connection position where the hydraulic circuit is connected to the second discharge oil passage;
a second shut-off valve provided between the second discharge oil passage in the hydraulic circuit and the master cylinder; and
a control unit configured to control each of the shut-off valves according to an activation state of each of the pumps.

15. The brake apparatus according to claim 14, wherein the control unit controls each of the pumps and each of the shut-off valves according to a result of detection by a vehicle state detection unit configured to detect a vehicle state.

16. The brake apparatus according to claim 15, wherein the second pump discharges a larger inherent discharge amount than the first pump.

17. The brake apparatus according to claim 15, wherein the control unit controls the second shut-off valve in a valve-closing direction and drives both the first pump and the second pump when sudden braking is detected by the vehicle state detection unit.

18. The brake apparatus according to claim 14, further comprising:
a first electric power source configured to supply electric power to the first pump and the first shut-off valve; and
a second electric power source configured to supply electric power to the second pump and the second shut-off valve.

19. A brake apparatus comprising:
a hydraulic circuit that connects a master cylinder configured to pressurize brake fluid according to a brake operation performed by a driver and a wheel cylinder configured to apply a braking force to a wheel according to a brake hydraulic pressure;
a first discharge oil passage connected to the hydraulic circuit;
a first pump configured to supply the brake fluid to the wheel cylinder via the first discharge oil passage;
a second discharge oil passage connected to the hydraulic circuit on one side closer to the master cylinder with respect to a connection position where the first discharge oil passage is connected to the hydraulic circuit;
a second pump configured to supply the brake fluid to the wheel cylinder via the second discharge oil passage, the second pump being configured to discharge a larger inherent discharge amount than the first pump;
a first shut-off valve provided between the connection position where the hydraulic circuit is connected to the first discharge oil passage, and a connection position where the hydraulic circuit is connected to the second discharge oil passage;
a second shut-off valve provided between the connection position where the hydraulic circuit is connected to the second discharge oil passage and the master cylinder; and
a control unit configured to selectively control each of the pumps and/or each of the shut-off valves.
